(19) United States
(12) Patent Application Publication
(10) Pub. No.: US 2013/0191756 A1
(43) Pub. Date: Jul. 25, 2013

(54) Analyzing Device Control System

(71) Applicant: SHIMADZU CORPORATION, Kyoto-shi (JP)

(72) Inventor: Takayuki KIHARA, Kyoto-shi (JP)

(73) Assignee: SHIMADZU CORPORATION, Kyoto-shi (JP)

(21) Appl. No.: 13/738,683

(22) Filed: Jan. 10, 2013

(30) Foreign Application Priority Data
Jan. 20, 2012 (JP) 2012-010395

(51) Int. Cl. G06F 3/0484

(52) U.S. Cl. CPC G06F 3/0484
USPC 715/740

(57) ABSTRACT

Provided is an analyzing device control system including an analyzing system and a control computer for controlling the analyzing device, the system having an improved visibility and operability of a user interface for remotely operating or monitoring the control computer from an external terminal through a data communication network. The control computer PC 1 includes: a size acquirer for obtaining the size of a display screen of an external terminal 4 connected to the control PC 1 via the Internet IN; a terminal-suited execution screen creator for creating data of a terminal-suited execution screen to be used for remotely operating the control PC 1 from the external terminal 4; a screen transmitter for sending the terminal-suited execution screen data to the external terminal 4; and a remote control executer for receiving information relating to an operation on the external terminal 4 and for performing the control of an analyzing device based on this information.

### TECHNICAL FIELD

The present invention relates to an analyzing device control system including an analyzing device and a computer for controlling the analyzing device. More specifically, it relates to a technique for remotely operating or monitoring the control computer.

### BACKGROUND ART

In an analysis using a liquid chromatograph or similar device, a measurement may be performed continuously over a long period of time or repeatedly while automatically selecting one sample after another among a large number of samples. An analyzing device capable of performing such an automatic, long-term operation is often operated in a virtually unattended state, with no operator standing by nearby the analyzing device. However, when some abnormality occurs in the course of the analysis or a manual judgment is needed to continue the operation, the analysis operator must perform some operation depending on the situation, such as suspending or discontinuing the operation, or changing the parameter settings.

A conventional system developed to deal with such a situation has the function of automatically creating a notifying e-mail (electronic mail) and sending it to one or more registered addresses when some abnormality or problem has occurred in the middle of an analysis, making it difficult to continue the analysis (for example, see Patent Document 1). With this system, even an analysis operator who is at a remote place from the analyzing device can recognize the abnormality of the analyzing device by reading the e-mail on a personal computer or mobile phone available at hand, and take the necessary measures.

In addition to this, another e-mail-based system has also been developed, which allows users to make a judgment according to the condition of the analyzing device and/or the result of an analysis, and remotely send the analyzing device a device-control command by e-mail to appropriately control the device (for example, see Patent Document 2).

### BACKGROUND ART DOCUMENT

### Patent Document

Patent Document 1: JP-A 10-215494
Patent Document 2: JP-A 2004-286663

### SUMMARY OF THE INVENTION

### Problem to be Solved by the Invention

The system disclosed in Patent Document 2 has a problem in that only a prepared set of control commands are allowed to be used. Another problem is that the effects of the control commands sent to the system by e-mail cannot be checked in real-time.

To solve these problems, the present inventor has conceived the idea of utilizing a technology called the “remote desktop.” The remote desktop is a technology prepared for operating a graphical user interface (GUI) on one computer from another computer through a computer network.

In recent years, the control of an analyzing device is often conducted via a personal computer (PC) or similar apparatus connected to the analyzing device, with a program for controlling the analyzing device installed therein. In the case of a GUI-based control system, an execution screen data of the program is displayed on the monitor of the PC. This execution screen serves as a user interface for controlling the analyzing device and showing the result of an analysis performed by the analyzing device.

In such a system including an analyzing device and a PC for controlling the analyzing device, when an external terminal is connected to the PC by using the remote desktop function, the screen data shown on the monitor of the PC (which is hereinafter called the “system screen”) will be directly shown on the display screen of the external terminal (which is hereinafter called the “terminal screen”) so that users can remotely control the analyzing device on the terminal screen. The information relating to the result of an analysis displayed on the system screen is also viewable on the terminal screen in real-time.

This useful system still has the problem that it is difficult to operate when a mobile phone or similar device is used as the terminal. Normally, the display screens of mobile devices are considerably smaller than those of PCs. Accordingly, in many cases, when the screen data on the system screen is shown on the terminal screen through the remote desktop function, the screen data is reduced in size so as to be fitted with the screen size of the terminal. Such a size reduction makes the texts, buttons and other U1 components too small to be read or operated.

On the other hand, if the screen data on the system screen is shown on the terminal screen without size reduction, users need to perform the time-consuming, troublesome operation of scrolling the screen data on the terminal screen to check through the entire screen data. The omission of size reduction may also cause the problem of low visibility. For example, a set of values that should be simultaneously monitored may not be completely included in the same screen.

Accordingly, the problem to be solved by the present invention is to provide an analyzing device control system including an analyzing system and a control computer (e.g. PC) for controlling the analyzing device, the system having an improved visibility and operability of a user interface for remotely operating or monitoring the control computer from an external terminal through a data communication network.

### Means for Solving the Problems

The present invention aimed at solving the previously described problems provides an analyzing device controlling system including a control computer having a controller for controlling an analyzing device and a system screen for showing an execution screen data of the controller, the control computer further including:

a) a size acquirer for acquiring, from a terminal screen of an external terminal connected through a data communication network, the size of the terminal screen;

b) a terminal-suited execution screen creator for creating a terminal-suited execution screen data suited for the size of the terminal screen;

c) a screen transmitter for transmitting the terminal-suited execution screen data through the data communication network to the external terminal; and

d) a remote control executer for making the controller perform a control of the analyzing device based on information concerning an operation on the external terminal received through the data communication network.

In the present invention, the external terminal is any type of terminal capable of performing data communications and also being connected to the analyzing device control system of the present invention through a data communication network. Primary examples of the external terminal are mobile phones, smart phones, tablet devices and other portable terminals (mobile terminals), although the present invention allows the use of a fixed terminal as the external terminal. It is also possible to provide the analyzing device with an external terminal or a functional unit serving as the external terminal.

The analyzing device control system according to the present invention is a system for remotely operating or monitoring a control computer from an external terminal through a data communication network, and is characterized in that a terminal-suited execution screen data prepared to be fitted with the size of the terminal screen of an external terminal is transmitted to the external terminal. Users of the external terminal can remotely operate or monitor the control computer, with high visibility and operability, through the terminal-suited execution screen displayed on the terminal screen.

The terminal-suited execution screen creator may have a plurality of terminal-suited execution screen data prepared for each different size of the terminal screen, instead of creating a terminal-suited execution screen data every time an external terminal is connected to the analyzing device control system.

The size acquirer may send the external terminal a predetermined program written in Javascript® or a similar programming language. This program is executed on the external terminal to acquire the size of the terminal screen and send the acquired data to the control computer.

Just in case the external terminal has no physical or software keyboard, it is preferable, from the viewpoint of operability, to provide the terminal-suited execution screen with an input element for allowing users to enter a character or figure by selecting a choice item on the screen by a clicking or touching operation.

### Effect of the Invention

In the analyzing device control system according to the present invention, when the control computer is remotely operated or monitored from an external terminal through a data communication network, a terminal-suited execution screen data having optimal visibility and operability for the screen size of the external terminal is displayed on the terminal screen. On the terminal-suited execution screen displayed on the terminal screen, users can remotely operate or monitor the control computer with high visibility and operability.

Incorporating a functional unit or operating system comparable to a PC in the analyzing device itself would make this device expensive. However, in the analyzing device control system according to the present invention, by incorporating an external terminal or a function unit serving as an external terminal in the analyzing device, an analyzing device can be realized whose actual functions and display screen are comparable to those of an external terminal and yet its virtual functions are comparable to those of an analyzing device with a PC incorporated therein.

### BRIEF DESCRIPTION OF THE DRAWINGS

FIG. 1 is a schematic configuration diagram showing one embodiment of the analyzing device control system according to the present invention.

FIG. 2 is a display example of an execution screen data of a control program on a system screen.

FIG. 3 is a display example of a terminal-suited execution screen data adjusted to a mobile terminal.

FIG. 4 is an example of the system screen of a control computer to which a mobile terminal connected.

FIG. 5 is an illustration for explaining a method of selectively displaying one of a plurality of terminal-suited execution screen data on the terminal screen.

### BEST MODE FOR CARRYING OUT THE INVENTION

One example of the analyzing device control system according to the present invention will be hereinafter described in detail, with reference to the drawings.

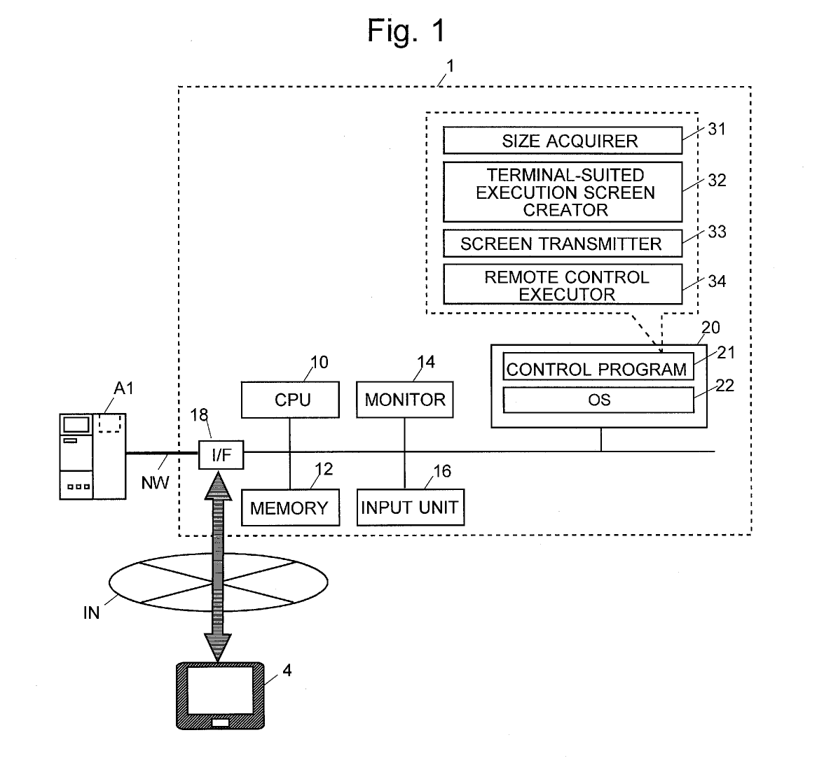

FIG. 1 shows one embodiment of the analyzing device control system according to the present invention. This system includes an analyzing device A1 and a control computer 1 (which is hereinafter called the “control PC 1”). For example, the analyzing device A1 is a liquid chromatograph, although the analyzing device in the present invention may be any type of analyzing or measuring device. It is also possible to include two or more analyzing devices in the analyzing device control system.

The control PC 1 is actually a computer having a central processing unit (CPU) 10 with various hardware components connected thereto, such as a memory 12, a monitor 14 (system screen), such as a liquid crystal display (LCD), an input unit 16 including a keyboard and mouse, as well as a storage unit 20 consisting of a large-capacity storage device, such as hard disk drive (HDD) or solid state drive (SSD). A control program 21 for controlling the analyzing device A1 and an operating system (OS) 22 are stored in the storage unit 20.

The control PC 1 has an interface (I/F) 18 for handling both a direct connection with an external device and an indirect connection with an external device or the like through a network, such as a local area network (LAN). Through this interface 18, the control PC 1 is connected to the analyzing device A1 via a network cable NW. It should be noted that the present invention does not always require the interface 18 to connect the control PC 1 to the analyzing device A1; for example, the control PC 1 may be incorporated in the analyzing device A1.

The control PC 1 can also be connected to the Internet IN via the interface 18. Through the Internet IN, the PC 1 can communicate with an external terminal 4.

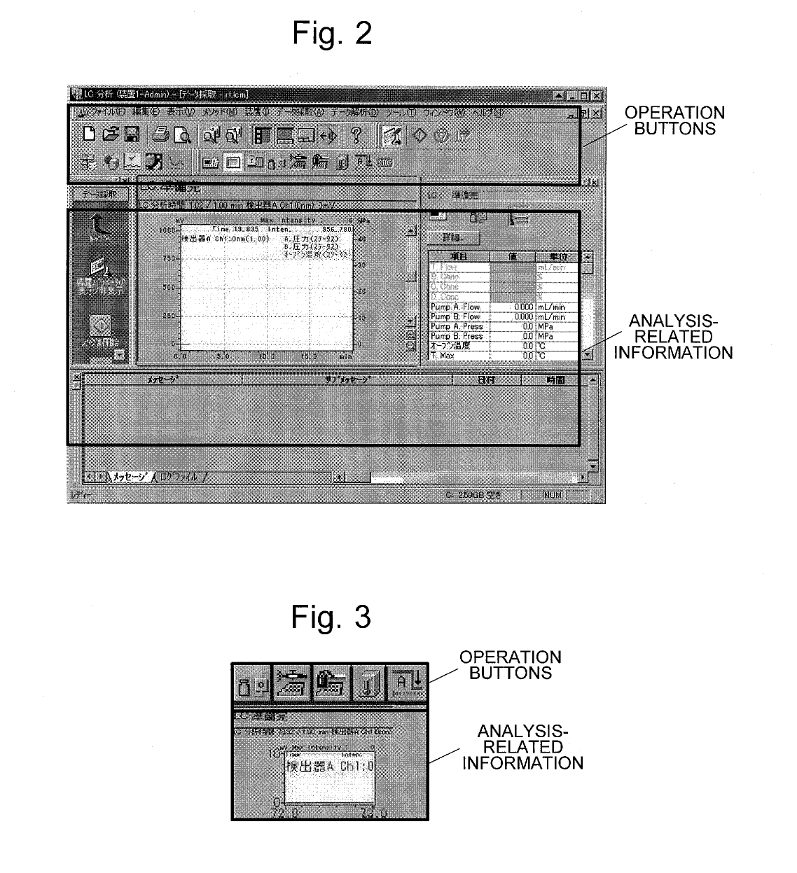

FIG. 2 is an example of an execution screen data of a control program 21 displayed on a system screen 14. As shown in FIG. 2, the execution screen contains various kinds of operation buttons and display areas for showing various kinds of analysis-related information, such as the input values or the result of an analysis. Watching the execution screen shown on the system screen 14, users can directly operate the control PC 1 by appropriately using the mouse and keyboard. In response to this operation, the control program 21 performs various controls for the analyzing device A1 and displays the result on the execution screen.

The control program 21 has the following functional blocks characteristic of the present invention: a size acquirer 31 for obtaining the size of a display screen (terminal screen) of the external terminal 4 when this terminal 4 is connected to the control PC 1 via the Internet IN; a terminal-suited execution screen creator 32 for creating data of a terminal-suited execution screen to be used for remotely operating the control PC 1 from the external terminal 4; a screen transmitter 33 for sending the terminal-suited execution screen data to the external terminal 4; and a remote control executer 34 for receiving information relating to an operation on the external terminal 4 and for performing the control of the analyzing device A1 based on this information.

Upon receiving a request for connection from the external terminal 4 to the control PC 1, the control program 21 performs the following operations:

Initially, the size acquirer 31 sends the external terminal 4 a predetermined program written in an appropriate programming language, such as Javascript™. This program is executed on the external terminal 4 to acquire the size of the terminal screen and send the data of the acquired size to the control PC 1.

When the control PC1 has received the size data from the external terminal 4, the terminal-suited execution screen creator 32, based on a predetermined algorithm, creates a terminal-suited execution screen data in which the numbers, arrangements and display sizes of the operation buttons and analysis-related information are suitably adjusted for the size of the terminal screen. For example, this can be achieved by selecting one of the style sheets or automatically creating a style sheet according to the size of the terminal screen.

FIG. 3 is a display example of the terminal-suited execution screen data created by the terminal-suited execution screen creator 32. As shown in FIG. 3, the terminal-suited execution screen has fewer operation buttons and fewer items of analysis-related information than those of the execution screen on the system screen 14 shown in FIG. 2. The arrangement and display size of the operation buttons and analysis-related information are also adjusted.

Taking into account this decrease in the numbers of operation buttons and items of analysis-related information, it is preferable to preferentially show an operation button and analysis-related information of a high level of importance on the terminal-suited execution screen. In the aforementioned case of automatically creating a style sheet for the terminal-suited screen data, it is preferable to previously set the importance level of each of the operation buttons or analysis-related information, and show the buttons and information in order of the importance level on the terminal-suited execution screen.

It is also possible to accumulate data relating to the used frequency of each operation button and the display frequency of each kind of analysis-related information, and show the buttons and information in order of these frequencies.

Furthermore, to allow users to easily input the value of a parameter or the like within the limited display area, a predetermined input wizard may be provided in the terminal-suited execution screen.

The screen transmitter 33 sends the external terminal 4 the terminal-suited execution screen data created by the terminal-suited execution screen creator 32. Watching the terminal-suited execution screen displayed on the terminal screen, a user operates the external terminal 4. Information of this operation is sent to the control PC 1 through the Internet IN. Based on this operation information received from the external terminal 4, the remote control executer 34 runs the control program 21.

The result obtained by running the control program 21 is reflected in the terminal-suited execution screen data, which are transmitted through the screen transmitter 33 to the external terminal 4. The user can check changes in the analysis-related information on the terminal screen.

Thus far, one embodiment of the analyzing device control system according to the present invention has been described. This system can be appropriately changed or modified within the spirit and scope of the present invention.

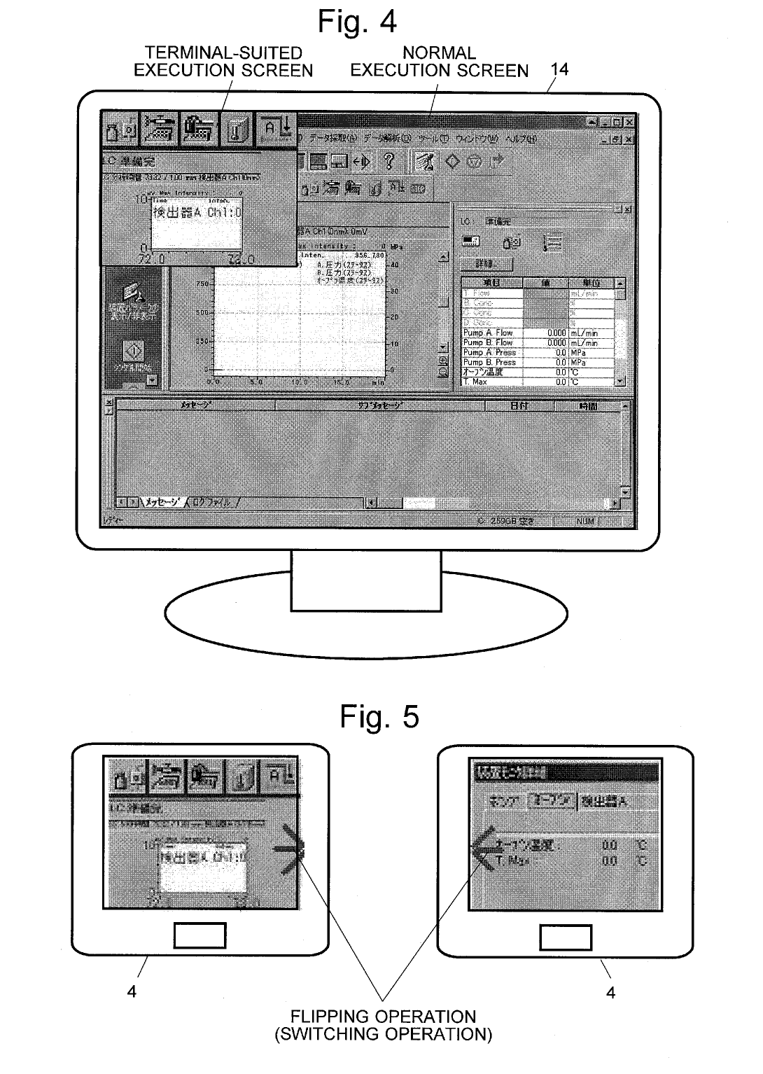

Fog example, the connection between the control PC 1 and the external terminal 4 may be achieved through a remote desktop function installed in the control PC 1. When the remote desktop function is used, the terminal-suited execution screen is also displayed on the system screen 14. In this case, as shown in FIG. 4, the terminal-suited execution screen on the external terminal 4 may be displayed foreground on the system screen 14, with the normal execution screen of FIG. 2 being displayed in the remaining area. It is also possible to leave the remaining area blank, or magnify the terminal-suited execution screen to make it fitted with the entire system screen 14.

As opposed to the previously described case in which the terminal-suited execution screen data is created for every acquisition of the size of the terminal screen from the external terminal 4, the terminal-suited execution screen creator 32 may use one of a plurality of terminal-suited execution screen data which have been prepared beforehand for each screen size and stored in a predetermined memory area of the storage unit 20.

The terminal-suited execution screen should preferably be provided with an input element for allowing users to enter a character or figure by selecting a choice item on the screen by a clicking or touching operation. This makes it possible to assuredly perform operations even in the case where the external terminal 4 is a mobile terminal with no physical or software keyboard.

The control program 21 may be provided with a display changer for allowing users to arbitrarily change the arrangement of operation buttons and the kinds of analysis-related information on the terminal-suited execution screen from the control PC 1 or the external terminal 4. By using this function, users can customize the screen according to their usage pattern so that the operation buttons that are most frequently used and/or the analysis-related information that should be checked will be assuredly shown on the external terminal 4.

Furthermore, as shown in FIG. 5, it is possible to prepare a plurality of different terminal-suited execution screen data and provide the terminal-suited execution screen with the function of switching from one terminal-suited execution screen to another upon detecting a predetermined screen-switching operation, such as a flipping operation, on the external terminal 4.

It is also possible to incorporate the external terminal 4, or a functional unit serving as the external terminal 4, in the analyzing device A1. In this case, while a user is operating the terminal-suited execution screen on the analyzing device A1, the actual control of the analyzing device A1 is conducted on the control PC 1 which has received information relating to the operation performed on the analyzing device A1. By adopting this design, the operability of the analyzing device A1 can be improved at nominal cost without incorporating an expensive OS or program as used in the control PC 1.

It is preferable to require a login (e.g. entry of user ID and password) for an initial access to the analyzing device control system from the external terminal 4. Such a login process ensures the security of the entire system against a connection from foreign external terminals.

It is preferable to previously set a rule for determining which user has a priority to enter information when there is one user remotely accessing the analyzing device control system through the external terminal 4 connected to the control PC 1 and another user directly using the same control PC 1. The basic policy should be to disallow entry of information from the low-priority side. However, just in case of emergency, such as an occurrence of a problem within the system, it is preferable that, when a predetermined operation is performed (e.g. an ESC key is pressed), the analyzing device control system disables the priority-based access control so as to allow the entry of information from the low-priority side.

In the previously described embodiment, it was assumed that the terminal screen of the external terminal 4 was smaller in size than the system screen 14. However, in some cases, the terminal screen of the external terminal 4 is larger in size than the system screen 14. In such a case, the terminal-suited execution screen data can be created so that a larger amount of information will be shown on the terminal-suited execution screen.

### EXPLANATION OF NUMERALS

1 . . . Control Computer (Control PC)
10 . . . Central Processing Unit (CPU)
12 . . . Memory
14 . . . Monitor (System Screen)
16 . . . Input Unit
18 . . . Interface (I/F)
20 . . . Storage Unit
21 . . . Control Program
22 . . . Operating System (OS)
31 . . . Size Acquirer
32 . . . Terminal-Suited Execution Screen Creator
33 . . . Screen Transmitter
34 . . . Remote Control Executer
4 . . . External Terminal
A1 . . . Analyzing Device
IN . . . Internet
NW . . . Network Cable

1. An analyzing device controlling system including a control computer having a controller for controlling an analyzing device and a system screen for showing an execution screen data of the controller, the control computer further comprising:
a) a size acquirer for acquiring, from a terminal screen of an external terminal connected through a data communication network, a size of the terminal screen;
b) a terminal-suited execution screen creator for creating a terminal-suited execution screen data suited for the size of the terminal screen;
c) a screen transmitter for transmitting the terminal-suited execution screen data through the data communication network to the external terminal; and
d) a remote control executer for making the controller perform a control of the analyzing device based on information concerning an operation on the external terminal received through the data communication network.

2. The analyzing device controlling system according to claim 1, wherein the terminal-suited execution screen data is selected from a plurality of previously created screen templates.

3. The analyzing device controlling system according to claim 1, wherein the terminal-suited execution screen data is created every time the control computer is connected to the external terminal.

4. The analyzing device controlling system according to claim 1, wherein a plurality of different terminal-suited execution screen data are prepared for a same size of the terminal screen, and the terminal-suited execution screen data to be sent to the external terminal is switched in response to a switch request from the external terminal.

5. The analyzing device controlling system according to claim 1, wherein the terminal-suited execution screen is provided with an input element for allowing users to enter a character or figure by selecting a choice item on the screen by a clicking or touching operation.

6. The analyzing device controlling system according to claim 1, wherein the control computer further comprises a display changer for allowing users to change an arrangement of operation buttons and kinds of analysis-related information on the terminal-suited execution screen.

7. The analyzing device controlling system according to claim 1, wherein an operation of logging in to the analyzing device controlling system is required when an initial connection between the control computer and the external terminal is established.

8. The analyzing device controlling system according to claim 1, wherein the connection between the control computer and the external terminal is achieved by means of a remote desktop function.

9. The analyzing device controlling system according to claim 1, wherein the control computer is incorporated in the analyzing device.

10. The analyzing device controlling system according to claim 1, wherein the external terminal or a functional unit corresponding to the external terminal is built in or mounted on the analyzing device.
